(19) United States
(12) Patent Application Publication
(10) Pub. No.: US 2025/0340099 A1
(43) Pub. Date: Nov. 6, 2025

(54) CABIN WARM-UP USING RESTRICTED AIRFLOW IN HEAT PUMP-BASED HEATING, VENTILATION, AND AIR CONDITIONING SYSTEM

(71) Applicant: GM GLOBAL TECHNOLOGY OPERATIONS LLC, Detroit, MI (US)

(72) Inventors: Cameron P. Smith, Milford, MI (US); Rupesh S. Kakade, West Bloomfield, MI (US); Goutham Ethiraj Shivashankar, Whitby (CA)

(73) Assignee: GM GLOBAL TECHNOLOGY OPERATIONS LLC, Detroit, MI (US)

(21) Appl. No.: 18/655,817

(22) Filed: May 6, 2024

(51) Int. Cl. B60H 1/00; B60H 1/32

(52) U.S. Cl. CPC B60H 1/00864; B60H 1/3213

(57) ABSTRACT

A heat pump-based heating, ventilation, and air conditioning (HVAC) system for heating a defined space, e.g., a vehicle cabin of a motor vehicle, includes a manifold, blower fan, refrigerant compressor, condensing heater, mixing door, door actuator, and electronic controller. The door is disposed between first and second conduits of the manifold. The actuator moves the door anywhere between and inclusive of a fully-closed position and a fully-open position to respectively block and unblock directed airflow in the first conduit and the second conduit. The controller, in response to input signals during a warm-up period of the defined space, modulates a position of the door and/or a rotary speed of the blower fan such that an amount of the directed airflow delivered through the first conduit to the condensing heater is reduced during the warm-up period.

### INTRODUCTION

Motor vehicles include a vehicle body that defines a vehicle interior or cabin. Motor vehicles are equipped with a heating, ventilation, and air conditioning (HVAC) system configured to circulate heated or air conditioned airflow through the vehicle cabin for the comfort of occupants seated therein. A user input device such as a rotary dial, touch screen, or voice commands permits an occupant of the vehicle cabin to select a desired cabin climate, e.g., a particular temperature or airflow level, the latter of which may be provided by a motorized blower fan. Occupants may use a similar input device to select various other HVAC functions such as front or rear defroster settings, or temperature setting of a heated steering wheel or heated seats.

To provide directed airflow to the vehicle cabin at a desired temperature, a vehicular HVAC system controls a coolant cycle during heating and cooling modes of operation. A battery electric vehicle (BEV), however, lacks an internal combustion engine and the copious generation of waste heat associated therewith. To that end, a BEV may incorporate smaller electric heaters and a heat pump-based HVAC system that relies on circulated refrigerant, e.g., R134a or R1234yf, in lieu of liquid coolant. After the refrigerant is compressed to a higher pressure, the higher pressure/temperature refrigerant stream may be directed to a condensing heater for heat dissipation into the vehicle cabin during a heating mode. The refrigerant thereafter passes through an expansion valve before entering a chiller/evaporator in a lower-pressure/lower-temperature state. Cold/air conditioned airflow may also be produced during a cooling mode by reversing the refrigerant cycle.

### SUMMARY

A heat pump-based heating, ventilation, and air conditioning (HVAC) system and associated method are described in detail herein for use in heating a defined space, e.g., a vehicle cabin of a representative motor vehicle. The HVAC system of the present disclosure includes a refrigerant compressor, a condensing heater, and an electronic controller. The present teachings in one or more implementations are intended to expedite warm-up of the vehicle cabin, e.g., of a battery electric vehicle (BEV). In one or more embodiments, warm-up is expedited upon initialization or startup of the BEV by purposefully reducing an amount of directed airflow across or through the condensing heater, for instance by shielding the condensing heater from the directed airflow via positioning of a moveable mixing door.

The shielding action maximizes the amount of heat generated by the refrigerant compressor, which due to an increase in head pressure or differential pressure across the compressor in some embodiments is forced into a less efficient mode of operation. Waste heat results from such an action, with the generated waste heat thus made available for cabin heating, e.g., to compensate for the lack of an internal combustion engine in a non-limiting BEV construction.

According to an exemplary embodiment, the heat pump-based HVAC system includes an airflow manifold, a blower fan, a refrigerant compressor, a condensing heater, a door actuator, a mixing door, and an electronic controller. The manifold includes an air inlet, an air outlet, and first and second conduits. The first and second conduits connect the air inlet and air outlet. The blower fan is disposed within the air inlet and operable for moving directed airflow into the first and second conduits. The compressor is configured to compress a supply of refrigerant, e.g., R134a or R1234yf, with the refrigerant included as part of the HVAC system in one or more embodiments. The condensing heater is in fluid communication with the compressor, with the first conduit passing over or through the condensing heater.

The mixing door in this embodiment is disposed between the first and second conduits, and optionally configured to translate between a pair of oppositely-disposed door stops. The door actuator is configured to move the mixing door anywhere between and inclusive of fully-closed and fully-open positions, with the fully-closed position and the fully-open position respectively blocking the directed airflow in the first conduit and the second conduit. The electronic controller, in response to input signals from one or more sensors during a warm-up period of the defined space, is configured to modulate a position of the mixing door and/or a rotary speed of the blower fan. Doing so thereby reduces an amount of the directed airflow through the first conduit to the condensing heater during the warm-up period.

The electronic controller in one or more embodiments is configured to generate the waste heat by selectively increasing a head pressure of the compressor via modulation of the position of the mixing door. The electronic controller may also command the door actuator to move the mixing door to the fully-closed position upon initialization of the HVAC system, thereby providing a minimum amount of the directed airflow to the condensing heater.

Additionally, the electronic controller may set a speed of the compressor to a calibrated minimum compressor speed upon the initialization of the HVAC system. In such an implementation, the electronic controller may thereafter increase the speed of the compressor until a head pressure of the refrigerant compressor reaches a maximum threshold pressure.

The electronic controller may be configured to command the door actuator to move the mixing door from the fully-closed position toward the fully-open position at a calibrated ramp rate until an outlet temperature of the condensing heater reaches a target outlet temperature, and to command the door actuator to move the mixing door to the fully-open position after the outlet temperature of the condensing heater drops below the target outlet temperature.

An aspect of the disclosure includes the input signals including a head pressure of the refrigerant compressor and an outlet temperature of the condensing heater.

The defined space may include a vehicle interior of a motor vehicle having a human-machine interface (HMI) device, with a target climate determined via a user input to the HMI device as one of the input signals.

Also disclosed herein is an electronic control system for a heat pump-based HVAC system of a vehicle cabin. An embodiment of the electronic control system includes a plurality of sensors operable for outputting a set of input signals, and an electronic controller having a processor and a non-transitory computer readable storage medium (“memory”) on which is recorded instructions. The instructions are executable by the processor to cause the electronic controller to receive and process the input signals from the sensors during a warm-up period of the vehicle cabin. In response to the input signals, the electronic controller selectively increases a head pressure of a refrigerant compressor via modulation of a position of a mixing door and/or a rotary speed of a blower fan. This action may include reducing an amount of a directed airflow to a condensing heater, wherein the HVAC system include the refrigerant compressor, the mixing door, the blower fan, and the condensing heater.

A motor vehicle as set forth herein includes a vehicle body defining a vehicle cabin, a set of road wheels connected to the vehicle body, an HMI device operable for receiving a target climate as a user input to the HMI device, and heat pump-based HVAC system for use in heating the vehicle cabin. The HVAC system includes an airflow manifold and an electronic controller in communication with a refrigerant compressor, a condensing heater, a blower fan, a mixing door disposed in the airflow manifold, and door actuator. The door actuator is operable to control a position of the mixing door within the airflow manifold.

The electronic controller in this construction is configured, in response to input signals during a warm-up period of the vehicle cabin, to selectively increase a head pressure of the refrigerant compressor by reducing a directed airflow to the condensing heater through a first conduit of the airflow manifold. This occurs via modulation of a position of the mixing door. Additionally, the electronic controller is configured to increase a head pressure of the refrigerant compressor by reducing the directed airflow via modulation of a position of the mixing door, wherein the input signals including the target climate, the head pressure of the refrigerant compressor, and an outlet temperature of the condensing heater.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 schematically illustrates a representative motor vehicle having a heat pump-based heating, ventilation, and air conditioning (HVAC) system constructed and controlled in accordance with the present disclosure.

FIG. 2 illustrates an embodiment of the HVAC system of FIG. 1.

FIG. 3 is a flow chart illustrating an exemplary method for warming up a vehicle cabin of the motor vehicle of FIG. 1 using the HVAC system illustrated in FIG. 2.

The appended drawings are not necessarily to scale, and may present a simplified representation of various preferred features of the present disclosure as disclosed herein, including for example specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, some embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

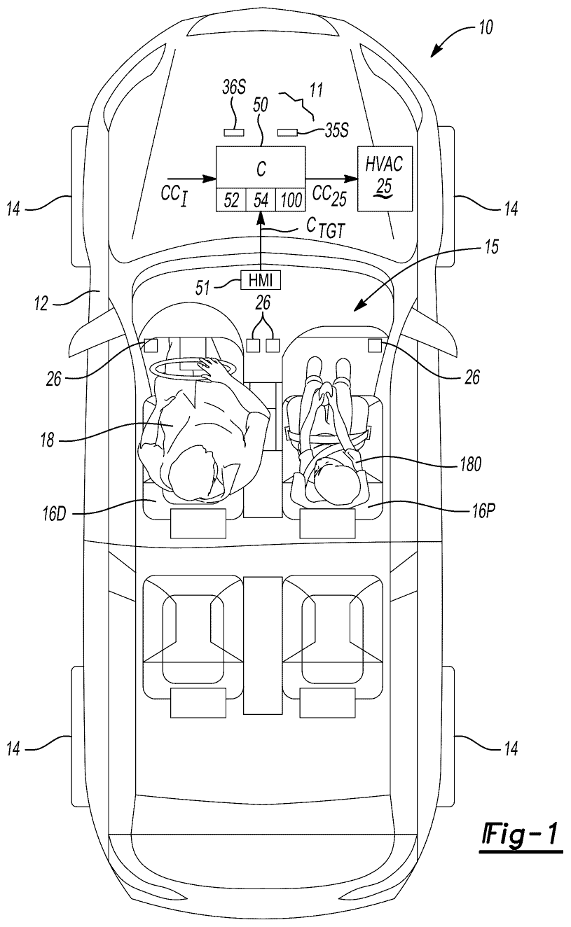

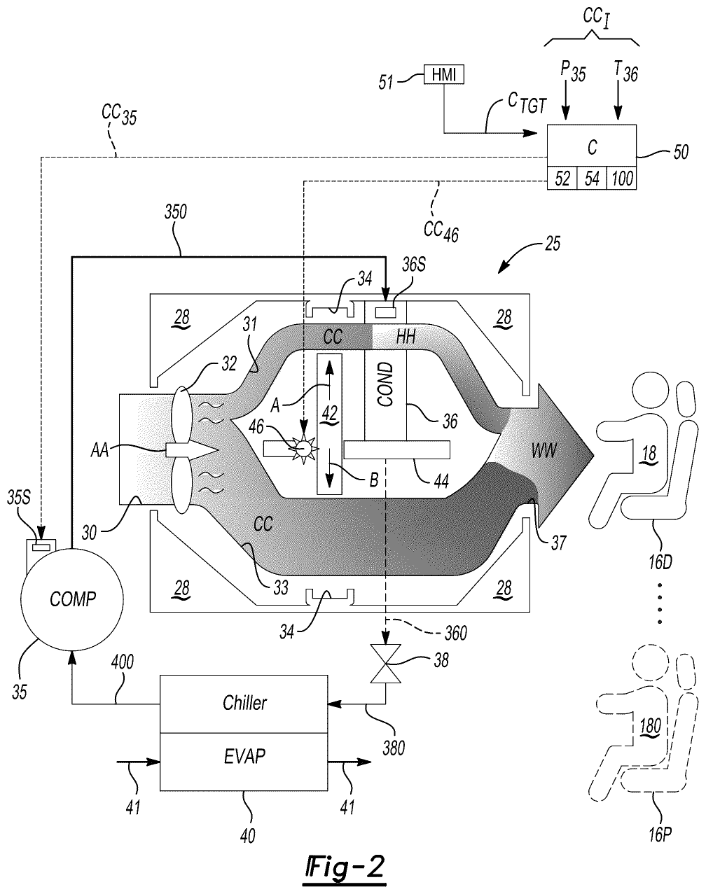

Referring now to the drawings, wherein like reference numbers refer to like features throughout the several views, FIG. 1 depicts a representative motor vehicle 10 having a vehicle body 12 defining a vehicle cabin 15. The motor vehicle 10 also includes a heat pump-based heating, ventilation, and air conditioning (HVAC) system 25, a non-limiting example embodiment of which is shown in FIG. 2. The HVAC system 25 includes or is in electronic communication with an electronic controller (C) 50, with the electronic controller 50 configured to control the HVAC system 25 in a particular manner when warming up the vehicle cabin 15 as described in detail below. Also as set forth below with particular reference to FIG. 2, the electronic controller 50 and a plurality of sensors (35S and 36S) form an electronic control system 11 for the HVAC system 25.

During a warm-up period of the vehicle cabin 15, e.g., upon starting the motor vehicle 10 after it has been parked for extended period in cold weather, or during similar warm-up of another defined space in non-vehicular embodiments, the rate of increase in the temperature of the vehicle cabin 15 may be too slow from the perspective of one or more passengers seated therewithin. This problem is often exacerbated when the motor vehicle 10 is characterized by an absence of an internal combustion engine or another large generator of waste heat that could otherwise be used for heating the vehicle cabin 15. For example, the motor vehicle 10 may be configured as a battery electric vehicle (BEV) as noted above. In such a case, the electronic controller 50 may be programmed to control operation of the HVAC system 25 to expedite warm-up for the enhanced comfort of passengers seated therein, e.g., a driver 18 and a passenger 180 seated on corresponding vehicle seats 16D and 16P as shown.

In a typical scenario, the driver 18 or the passenger 180 may open/close and direct airflow into the vehicle cabin 15 via one or more vents 26. A user interface device such as a touch screen of an information and entertainment (“infotainment”) system, navigation system, or other human-machine interface (HMI) device 51 may be located in a center console or dashboard of the vehicle interior 15, with the HMI device 51 being in wired or wireless communication with the electronic controller 50. Using the HMI device 51, or possibly using other devices such as a smart phone, tablet computer, etc., occupants of the vehicle interior 15 may input a climate preference as a target climate (CC_{TGT}) to the electronic controller 50 for mode control of the HVAC system 25.

The electronic controller 50 of FIGS. 1 and 2 as constructed herein may be embodied as microcontroller, electronic control unit, Application Specific Integrated Circuit(s) (ASIC), Field-Programmable Gate Array (FPGA), electronic circuit(s), central processing unit(s), e.g., microprocessor(s) and associated transitory and non-transitory memory/storage component(s). The electronic controller 50 is depicted schematically as having a processor 52 of one or more of such types, as well as a computer-readable storage medium or memory 54.

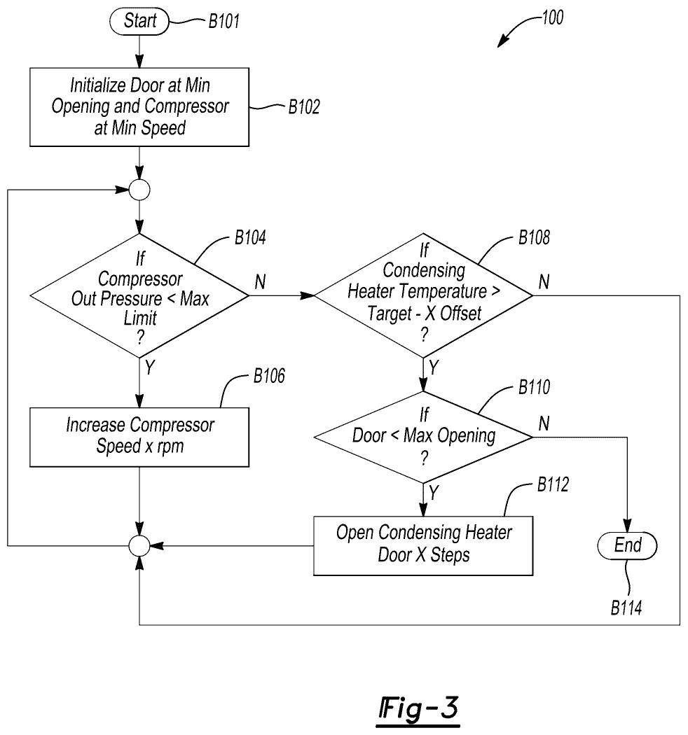

The memory 54 includes at least one tangible, non-transitory computer storage medium/media (e.g., read only, programmable read only, solid-state, random access, optical, magnetic, etc.). The memory 54, on which computer-readable instructions may be recorded embodying a method 100 (an example of which described below with reference to FIG. 3), is configured to store a machine-readable instruction set in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from a plurality of sensors, with such inputs monitored at a preset sampling frequency or in response to a triggering event. Software, firmware, programs, instructions, control routines, code, algorithms, and similar terms mean controller-executable instruction sets including calibrations and look-up tables. Ultimately, the electronic controller 50 of FIG. 1 outputs electronic control signals (CC₂₅) to the HVAC system 25 in accordance with the method 100 as described below.

In a possible implementation, the motor vehicle 10 illustrated FIG. 1 may be configured as a BEV, or alternatively as a plug-in hybrid electric vehicle (PHEV) or another mobile system having an electrified powertrain, as appreciated in the art. Although omitted for illustrative simplicity from FIG. 1, such powertrain systems may be used to convert stored energy in a traction battery pack into mechanical rotation of one or more road wheels 14 connected to the vehicle body 12. The vehicle body 12 may be that of a passenger sedan as shown, or alternatively a truck, van, delivery vehicle, farm equipment, or other mobile platform. The present teachings are not limited to vehicular use, but rather may be employed when using the HVAC system 25 to heat a defined space, for example a room of a residential or commercial building, a cockpit of an aircraft, an engineer's cab of a rail vehicle, etc. The motor vehicle 10 of FIG. 1 is described for illustrative consistency below without limiting the present teachings to such an implementation.

As appreciated by those skilled in the art and noted briefly above, motor vehicles employing an internal combustion engine as a prime mover produce large amounts of waste heat due to the exothermic nature of the fuel combustion process. This waste heat is typically collected via a circulating volume of liquid coolant and dissipated to the ambient environment via a radiator, which in turn is disposed at a forward end of the vehicle body. When vehicle cabin heating is desired in such a vehicle, heat from the liquid coolant may be transferred to the vehicle cabin via a heater core. In contrast, a BEV generates relatively very little waste heat, and therefore is typically equipped with electric heaters to help warm the vehicle cabin. The present HVAC system 25, which works via heat pump principles and the use of refrigerant, is specially modified to function in response to the electronic control signals (CC₂₅) from the electronic controller 50 to expeditiously warm the vehicle cabin 15 of FIG. 1.

Referring to FIG. 2, the heat pump-based HVAC system 25 is illustrated in accordance with a representative configuration to include an airflow manifold 28 having an air inlet 30, an air outlet 37, a first conduit 31, and a second conduit 33. The respective first and second conduits 31 and 33 connect the air inlet 30 to the air outlet 37. The air outlet 37 is in fluid communication with the vents 26 illustrated in FIG. 1. The HVAC system 25 is thus controllable to circulate, filter, and heat or cool airflow that the HVAC system 25 supplies to the vehicle interior 15. To this end, the HVAC system 25 includes a motorized blower fan 32 disposed within the air inlet 30 and operable for moving directed air (AA), i.e., ambient airflow, into the first conduit 31 and the second conduit 33. Additionally, the HVAC system 25 includes a refrigerant compressor (COMP) 35 configured to compress a first refrigerant stream 400, e.g., R134a or R1234yf, and a condensing heater (COND) 36 that is in fluid communication with the refrigerant compressor 35.

As part of the present control strategy, the electronic controller 50 is in communication with a mixing door 42—also referred to in the art as a temperature door—disposed in the manifold 28 between the first and second conduits 31 and 33. The mixing door 42 is operatively connected to a door actuator 46 such as a geared drive motor or another suitable rotary or linear actuator, and therefore is configured to close or open via commanded actuation of the door actuator 46, as indicated by arrow A and B, respectively. That is, the electronic controller 50 may transmit door control signals (CC₄₆) to the door actuator 46 to cause the door actuator 46 to move the mixing door 42 in a particular direction, e.g., toward one of a pair of oppositely-disposed door stops 34 of the manifold 28 when the mixing door 42 is configured as a linearly translating door akin to a pocket door. The door control signals (CC₄₆) in a possible embodiment may be proportional voltage signals operable for moving the mixing door 42 by a commanded angular or linear distance in a particular direction.

When the mixing door 42 moves relative to a door support 44 in the direction of arrow A to a fully-closed position, the mixing door 42 blocks directed airflow through the first conduit 31. Thus, a minimum amount of the directed airflow (and possibly no directed airflow) is provided to the condensing heater 36, e.g., at start up or upon initialization of the HVAC system 25. Similarly, the mixing door 42 when moved in the direction of arrow B will block directed airflow through the second conduit 33 when the mixing door 42 is in a fully-closed position. Depending on the position of the mixing door 42 anywhere between the fully-open and fully-closed positions, a mixture of hot air (HH) and cold air (CC) will exit the air outlet 37, with resulting warm air (WW) shown in FIG. 2 being directed toward the driver 18 seated in the driver seat 16D. In embodiments in the which the motor vehicle 10 of FIG. 1 is equipped with dual climate control capabilities, the passenger 180 seated in passenger seat 16P may independently control a separate mixing door to achieve a different mixture of the hot air (HH) and cold air (CC), as appreciated in the art.

Still referring to FIG. 2, the HVAC system 25 may also include a chiller/evaporator 40 operable to circulate the first refrigerant stream 400 to the refrigerant compressor 35 as noted above. As understood in the art, a chiller is a type of coolant-to-refrigerant heat exchanger, with coolant flow through the chiller/evaporator 40 indicated in FIG. 2 by arrows 41. In a non-limiting BEV implementation aboard the motor vehicle 10 of FIG. 1, use of chiller capabilities as part of the chiller/evaporator 40 enables the chiller/evaporator 40 to draw waste heat from a propulsion battery (not shown) as a heat source. Other heat sources may be used in other implementations, including but not limited to an airside evaporator, and therefore the specific embodiment of FIG. 2 is exemplary and non-limiting of the present teachings.

In the representative implementation of FIG. 2, a second refrigerant stream 350 is directed from the refrigerant compressor 35 to the condensing heater 36, with the second refrigerant stream 350 being in a superheated, relatively high-pressure state. Operation of the condensing heater 36 results in a third refrigerant stream 360 having a sub-cooled liquid state. The third refrigerant stream 360 thereafter passes through an expansion valve 38, which effectively lowers the pressure and temperature of the refrigerant stream 360, thereby producing a fourth refrigerant stream 380. The refrigerant stream 380, which is a mixture of liquid and gaseous refrigerant, is then heated by operation of the chiller/evaporator 40 to produce the first refrigerant stream 400. The refrigerant cycle thereafter repeats.

Still referring to FIG. 2, the electronic controller 50 is in wired or wireless communication with the various components of the HVAC system 25, and may be considered as part of the HVAC system 25 in one or more embodiments. The electronic controller 50 is in communication with the refrigerant compressor 35, the blower fan 32, and the door actuator 46. Within the scope of the disclosure, the electronic controller 50 is programmed, during a warm-up period of the vehicle interior 15 of FIG. 1 (or another defined space in other embodiments), to selectively reduce an amount of directed airflow to the condensing heater 36. In some embodiments, the programmed actions of the electronic controller 50 when controlling the position of the mixing door 42 will increase the head pressure of the refrigerant compressor 35. As understood in the art, head pressure is the high-side/discharge pressure (P₃₅) produced by the refrigerant compressor 35. This selective increase in head pressure occurs by at least partially reducing airflow through the first conduit 31, either alone or possibly in conjunction with speed control of the blower fan 32. The generated waste heat from the refrigerant compressor 35 is thereafter used to heat the vehicle cabin 15.

When controlling the HVAC system 25 through its various states and refrigerant state transitions, the electronic controller 50 may receive input signals (CC_{I}) in the form of the head pressure (P₃₅) of the refrigerant compressor 35 and an outlet temperature (T₃₆) of the condensing heater 36, which may be measured via a plurality of sensors 35S and 36S, e.g., a pressure sensor connected to the refrigerant compressor 35 and a temperature sensor connected to the condensing heater 36, respectively.

The input signals (CC_{I}) may also include the target climate (C_{TGT}) for the vehicle cabin 15, which may be communicated to the electronic controller 50 via the HMI 51, e.g., as touch screen inputs or using dials, knobs, or hands-free voice commands. In response to the input signals (CC₁), the electronic controller 50 communicates compressor control signals (CC₃₅) to the refrigerant compressor 35 to set its compressor speed and control its compression function, and thus affect the head pressure (P₃₅) of the refrigerant compressor 35 and the outlet temperature (T₃₆) of the condensing heater 36. As part of the method 100 described below, the controller 50 is also operable to transmit the door control signals (CC₄₆) to the door actuator 46 to control angular or linear position of the mixing door 42.

Referring now to FIG. 3, the method 100 is described according to an exemplary embodiment in which the electronic controller 50 of FIGS. 1 and 2 controls a position of the mixing door 42 of FIG. 2 to achieve the desired ends. The method 100 is illustrated and described using algorithm code segments or logic blocks that are executable by the processor 52 of the electronic controller 50 shown in FIGS. 1 and 2 when performing the described functions.

Beginning with block B101, i.e., “Start”, the electronic controller 50 may commence execution of the method 100 with a key-on event of the motor vehicle 10 of FIG. 1, typically at the start of a drive cycle after the motor vehicle 10. For instance, when the motor vehicle 10 is configured as a BEV, the driver 18 of FIG. 1 may press an ignition or start button (not shown) to initiate a propulsion mode. The method 100 thereafter proceeds to block B102 after this occurs.

Block B102 includes initializing control of the mixing door 42 of FIG. 2 at a minimum opening position, i.e., with the mixing door 42 moved in the direction of arrow A and thus substantially or fully blocking directed airflow through the first conduit 31. At the same time, the electronic controller 50 may set the refrigerant compressor 35 of FIG. 2 to a calibrated minimum speed. The two control actions are commanded via the door control signals (CC₄₆) and the compressor control signals (CC₃₅) of FIG. 2, respectively. The method 100 then proceeds to block B104.

Block B104 entails comparing the outlet pressure of the compressor 35, i.e., the head pressure (P₃₅) of FIG. 2, to a calibrated maximum pressure limit, e.g., a hardware limit of the refrigerant compressor 35. The method 100 proceeds to block B106 when the electronic controller 50 has determined that the head pressure (P₃₅) is less than the calibrated maximum pressure and therefore may be increased as part of the method 100, and to block B108 in the alternative when the head pressure (P₃₅) is greater than the calibrated maximum pressure.

At block B106, with the electronic controller 50 having determined at block B104 that head pressure (P₃₅) may be increased, responds by ramping up the speed of the refrigerant compressor 35 shown in FIG. 2 by a predetermined number of revolutions per minute (x rpm) or at a calibrated ramp rate. This may occur via adjustment of the compressor control signals (CC₃₅). The adjustment at block B106 may be made as a corresponding value that is proportional to the difference in head pressure (P₃₅) and the calibrated maximum pressure from block B104. The method 100 then proceeds to block B104.

Block B108 of FIG. 3 includes determining, via the controller 50 of FIGS. 1 and 2, whether the outlet temperature (T₃₆) of the condensing heater 36 exceeds a target outlet temperature less a calibrated offset. The inclusion of the small offset (effectively a hysteresis band) is desirable to avoid overshoot of responsive control actions, as will be appreciated in the art. The method 100 proceeds to block B110 when the outlet temperature (T₃₆) exceeds the calibrated target outlet temperature less the calibrated offset, which is indicative of the condensing heater 36 (FIG. 2) having excess waste heat usable for warming the vehicle cabin 15 (FIG. 1). The method 100 of FIG. 3 proceeds to block B104 in the alternative when the outlet temperature (T₃₆) is less than the target outlet temperature less the calibrated offset.

At block B110 of FIG. 3, the electronic controller 50 next determines whether the mixing door 42 of FIG. 2 is presently in a position less than a maximum opening position, i.e., the mixing door 42 is not yet in a fully-open position. The method 100 proceeds to block B114 (“End”) when the mixing door 42 is in a fully-open position. Otherwise, the method 100 proceeds in the alternative to block B112.

At block B112, the electronic controller 50 commands the mixing door 42 of FIG. 2 to open by an additional amount. For instance, the electronic controller 50 may command the door actuator 46 of FIG. 2, via the door control signals (CC₄₆), to open by one or more (“X”) steps, or predetermined linear or angular distances of the mixing door 42 depending on its translating or pivoting construction. The method 100 thereafter proceeds to block B104.

Block B114 represents termination of the method 100. That is, the electronic controller 50 of FIGS. 1 and 2 maintains the target climate of the vehicle interior 15 once the mixing door 42 has fully opened. The method 100 is complete, and may commence anew with block B101 at the next startup of the motor vehicle 10 shown in FIG. 1.

Using the teachings set forth above with reference to FIGS. 1, 2, and 3, it is therefore possible to operate the refrigerant compressor 35 of FIG. 2 at an inefficient operating point so as to generate waste heat, and to use the waste heat for the purpose of warming up the vehicle interior 15. For embodiments in which the HVAC system 25 of FIGS. 1 and 2 is used aboard a BEV, for instance, the condensing heater 36 may be undersized relative to condensers of vehicles powered by an internal combustion engine. A solution as set forth herein is to inefficiently run the refrigerant compressor 35 for a time in order to generate waste heat. The additional heat is made available for warmup of the vehicle interior 15. As described above, during a warm-up period of the vehicle cabin 15, the speed of the refrigerant compressor 35 is increased until the head pressure (P₃₅) reaches a calibrated or predetermined maximum. As the refrigerant compressor 35 will run more inefficiently at higher head pressures (P₃₅), i.e., at higher differential pressures across the refrigerant compressor 35, the act of temporarily starving the condensing heater 36 of airflow at the onset of the warm-up period thus acts as a counterintuitive approach toward expediting warm-up of the vehicle cabin 15.

As part of the method 100, the mixing door 42 is slowly ramped open to increase airflow across the condensing heater 36 of FIG. 2. This occurs until the outlet temperature (T₃₆) of the condensing heater 36 drops below the target at block B108. The increase in airflow over the condensing heater 36 results in the head pressure (P₃₅) and outlet temperature (T₃₆) dropping. The process repeats until the mixing door 42 of FIG. 2 is fully open in embodiments using the positioning control of the mixing door 42, or modulating airflow across the condensing heater 36 in other ways, e.g., via control of the motorized blower fan 32 and/or directing airflow to other potentially unused areas of the vehicle interior 15 at the onset of the warmup period, e.g., to an unoccupied rear seat.

Communication used herein may include exchanging data signals, e.g., electrical signals via a conductive medium, electromagnetic signals via air, optical signals via optical waveguides, etc. The data signals may include discrete, analog, and/or digitized analog signals representing inputs from the various disclosed or other sensors, actuator commands, and communication between controllers. The term “signal” may refer to a physically discernible indicator that conveys information, and that may be a suitable waveform (e.g., electrical, optical, magnetic, mechanical, or electromagnetic), such as direct current, alternating current, sinusoidal-wave, triangular-wave, square-wave, vibration, and the like, that is capable of traveling through a medium. The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

Aspects of the present disclosure have been described in detail with reference to the illustrated embodiments. Those skilled in the art will recognize, however, that many modifications may be made thereto without departing from the scope of the present disclosure. The present disclosure is not limited to the precise construction and compositions disclosed herein. Modifications, changes, and variations apparent from the foregoing descriptions are within the scope of the disclosure as defined by the appended claims. Moreover, the present concepts expressly include combinations and subcombinations of the preceding elements and features.

What is claimed is:

1. A heat pump-based heating, ventilation, and air conditioning (HVAC) system for use in heating a defined space, comprising:
an airflow manifold having an air inlet, an air outlet, a first conduit, and a second conduit, wherein the first conduit and the second conduit connect the air inlet to the air outlet;
a blower fan disposed within the inlet and operable for moving a directed airflow into the first conduit and the second conduit;
a refrigerant compressor;
a condensing heater in fluid communication with the refrigerant compressor, wherein the first conduit passes over or through the condensing heater;
a mixing door disposed between the first conduit and the second conduit;
a door actuator configured to move the mixing door anywhere between and inclusive of a fully-closed position and a fully-open position, the fully-closed position and the fully-open position respectively blocking the directed airflow in the first conduit and the second conduit; and
an electronic controller configured, in response to input signals from one or more sensors during a warm-up period of the defined space, to modulate a position of the mixing door and/or a rotary speed of the blower fan, such that an amount of the directed airflow that is delivered through the first conduit to the condensing heater is reduced during the warm-up period, thereby generating waste heat via the refrigerant compressor.

2. The heat pump-based HVAC system of claim 1, wherein the electronic controller is configured to generate the waste heat by selectively increasing a head pressure of the compressor via modulation of the position of the mixing door.

3. The heat pump-based HVAC system of claim 1, wherein the electronic controller is configured to command the door actuator to move the mixing door to the fully-closed position upon initialization of the HVAC system, and to thereby provide a minimum amount of the directed airflow to the condensing heater.

4. The heat pump-based HVAC system of claim 3, wherein the electronic controller is configured to:
set a speed of the compressor to a calibrated minimum compressor speed upon the initialization of the HVAC system; and
thereafter increase the speed of the compressor until a head pressure of the refrigerant compressor reaches a maximum threshold pressure.

5. The heat pump-based HVAC system of claim 3, wherein the electronic controller is configured to command the door actuator to move the mixing door from the fully-closed position toward the fully-open position at a calibrated ramp rate until an outlet temperature of the condensing heater reaches a target outlet temperature.

6. The heat pump-based HVAC system of claim 5, wherein the electronic controller is configured to command the door actuator to move the mixing door to the fully-open position after the outlet temperature of the condensing heater drops below the target outlet temperature.

7. The heat pump-based HVAC system of claim 1, wherein the mixing door is configured to translate between a pair of oppositely-disposed door stops.

8. The heat pump-based HVAC system of claim 1, further comprising:
a supply of refrigerant, wherein the supply of refrigerant includes R134a or R1234yf.

9. The heat pump-based HVAC system of claim 1, wherein the input signals include a head pressure of the refrigerant compressor and an outlet temperature of the condensing heater.

10. The heat pump-based HVAC system of claim 9, wherein the defined space includes a vehicle interior of a motor vehicle having a human-machine interface (HMI) device, and wherein a target climate is determined via a user input to the HMI device, the target climate being one of the input signals.

11. An electronic control system for a heat pump-based heating, ventilation, and air conditioning (HVAC) system of a vehicle cabin, comprising:
a plurality of sensors operable for outputting a set of input signals; and
an electronic controller having a processor and a non-transitory computer readable storage medium (“memory”) on which is recorded instructions, the instructions being executable by the processor to cause the electronic controller to:
receive and process the input signals from the plurality of sensors during a warm-up period of the vehicle cabin; and
in response to the input signals, selectively increase a head pressure of a refrigerant compressor via modulation of a position of a mixing door and/or a rotary speed of a blower fan, including reducing an amount of a directed airflow to a condensing heater, wherein the HVAC system includes the refrigerant compressor, the mixing door, the blower fan, and the condensing heater.

12. The electronic control system of claim 11, wherein the mixing door is coupled to a door actuator that is configured to move the mixing door anywhere between and inclusive of a fully-closed position to block the directed airflow to the condensing heater and a fully-open position to unblock the directed airflow to the condensing heater, and wherein the instructions are executable by the processor to cause the electronic controller to modulate the position of the mixing door via transmission of door control signals to the door actuator.

13. The electronic control system of claim 12, wherein the instructions are executable by the processor to cause the electronic controller to command the door actuator to move the mixing door to a fully-closed position upon initialization of the HVAC system, and to thereby provide a minimum amount of the directed airflow to the condensing heater.

14. The electronic control system of claim 13, wherein the instructions are executable by the processor to cause the electronic controller to:
set a speed of the compressor to a calibrated minimum compressor speed upon the initialization of the HVAC system; and
thereafter increase the compressor speed until a head pressure of the refrigerant compressor reaches a maximum threshold pressure.

15. The electronic control system of claim 12, wherein the instructions are executable by the processor to cause the electronic controller to command the door actuator to move the mixing door from the fully-closed position toward the fully-open position at a calibrated rate until an outlet temperature of the condensing heater reaches a target outlet temperature.

16. The electronic control system of claim 12, wherein the plurality of sensors operable for outputting the set of input signals includes a pressure sensor connected to the refrigerant compressor and a temperature sensor connected to the condensing heater.

17. A motor vehicle comprising:
a vehicle body defining a vehicle cabin;
a set of road wheels connected to the vehicle body;
a human-machine interface (HMI) device operable for receiving a target climate as a user input to the HMI device; and
a heat pump-based heating, ventilation, and air conditioning (HVAC) system for use in heating the vehicle cabin, the HVAC system including an airflow manifold and an electronic controller in communication with a refrigerant compressor, a condensing heater, a blower fan, and a mixing door disposed in the airflow manifold, and door actuator operable to control a position of the mixing door within the airflow manifold, wherein the electronic controller is configured, in response to input signals during a warm-up period of the vehicle cabin, to:
selectively increase a head pressure of the refrigerant compressor by reducing a directed airflow to the condensing heater through a first conduit of the airflow manifold, via modulation of a position of the mixing door; and
increase a head pressure of the refrigerant compressor by reducing the directed airflow via modulation of a position of the mixing door, wherein the input signals including the target climate, the head pressure of the refrigerant compressor, and an outlet temperature of the condensing heater.

18. The motor vehicle of claim 17, wherein the electronic controller is configured to:
command the door actuator to move the mixing door to a fully-closed position upon initialization of the HVAC system and thereby reduce the directed airflow to the condensing heater;
set a speed of the refrigerant compressor to a calibrated minimum compressor speed upon the initialization of the HVAC system; and
increase the speed of the refrigerant compressor until the head pressure reaches a maximum threshold pressure.

19. The motor vehicle of claim 18, wherein the electronic controller is configured to:
command the door actuator to move the mixing door from the fully-closed position toward a fully-open position at a calibrated rate until an outlet temperature of the condensing heater reaches a target outlet temperature; and
command the door actuator to hold the mixing door at the fully-open position after the outlet temperature of the condensing heater drops below the target outlet temperature.

20. The motor vehicle of claim 17, wherein the electronic controller is configured to modulate a rotary speed of the blower fan during the warm-up period.
